(19) United States
(12) Patent Application Publication
(10) Pub. No.: US 2026/0362300 A1
(43) Pub. Date: Nov. 12, 2026

(54) NON-TERRESTRIAL SCANNING FOR IMPROVED SIGNAL ACQUISITION IN NO TERRESTRIAL COVERAGE AREAS

(71) Applicant: T-MOBILE INNOVATIONS LLC, Overland Park, KS (US)

(72) Inventors: Jacob Andrew Fontana, Kirkland, WA (US); Sharath Somashekar, Overland Park, KS (US)

(21) Appl. No.: 19/203,829

(22) Filed: May 9, 2025

(51) Int. Cl. H04W 48/16

(52) U.S. Cl. CPC H04W 48/16

(57) ABSTRACT

Embodiments include improving signal acquisition from non-terrestrial nodes in a wireless communication network. A scanning algorithm on user equipment (UE) includes multiple sub-algorithms including a standard sub-algorithm that scans terrestrial spectrum bands (TSBs). Based on determining that there is no terrestrial signal, the UE executes a transient sub-algorithm that prioritizes scanning non-terrestrial spectrum bands (NTBs). If no signal is acquired still, the UE executes a no coverage sub-algorithm that prioritizes battery life while still scanning TSBs and NTBs. If a non-terrestrial signal is acquired, the UE establishes a connection with the wireless network. Active UEs execute an active sub-algorithm that prioritizes maintaining the connection while still scanning the TSBs. Idle UEs execute an idle sub-algorithm that prioritizes ensuring the non-terrestrial signal is available while still scanning the TSBs. If a terrestrial signal is acquired at any time, the UE returns to executing the standard sub-algorithm.

### TECHNICAL FIELD

Various embodiments of the present technology relate to wireless networks, and more specifically, to scanning algorithms on mobile devices used to connect to wireless networks.

### BACKGROUND

Wireless communication networks are pervasive, with approximately 70% of the world's population believed to have a cellular phone. One critical feature is the ability for a cellular phone (i.e., user equipment) to scan across multiple frequency bands to acquire a signal to attach to the wireless network. Most UEs possess the capability to scan all frequency bands of the wireless spectrum of frequencies to ensure the ability to access frequencies assigned to various carriers. In a wireless network having terrestrial access nodes (i.e., a terrestrial network), this capability allows the UE to acquire a signal initially (e.g., during power on) or upon loss of signal. In terrestrial networks the process is generally quick and efficient since terrestrial signals are typically present and usable. For example, a UE powering on will acquire a signal quickly from the nearest terrestrial access node because the terrestrial access node will consistently transmit the signal on one or more usable bands without changes to parameters such as Physical Cell Identity (PCI) and access node identity (e.g., eNB ID).

However, challenges have arisen with the introduction of satellites as non-terrestrial access nodes (i.e., non-terrestrial network) in the wireless network. Satellites are rapidly moving and may utilize multiple beams per satellite, which often shift as the satellite moves along is orbit. This creates a highly variable signal, and parameters such as PCI, which represents a specific beam, and the access node identity quickly change. Signal acquisition is further hindered due to the low dynamic range of reference signal received power (RSRP), reference signal received quality (RSRQ), and signal-to-interference-plus-noise ratio (SINR). These make it difficult for the UE to decode the initial signal. To add further to the challenges, doppler shifting and propagation delay make random access channel (RACH) and initial synchronization more difficult.

Despite these challenges, existing UEs use the same scanning algorithm, which scans all frequency bands regardless of the situation. As such, in areas without coverage where a non-terrestrial network could be utilized, many signal acquisition opportunities are missed. Accordingly, improvements are needed.

### SUMMARY

Various embodiments of the present technology relate improving signal acquisition of non-terrestrial signals in no terrestrial coverage scenarios. A user equipment (UE) may execute a scanning algorithm to acquire or maintain a signal for attaching to a wireless communication network. Using the standard scanning sub-algorithm of a scanning algorithm, the UE may determine it is in a no terrestrial coverage area. The standard scanning sub-algorithm includes scanning terrestrial spectrum bands of a wireless spectrum of frequencies. Upon making such determination, the UE executes a transient no coverage scanning sub-algorithm that prioritizes scanning non-terrestrial spectrum bands of the wireless spectrum. Based upon whether a non-terrestrial signal is acquired, further sub-algorithms are executed to preserve battery life of the UE or maintain any signal acquired with a non-terrestrial access node.

One general aspect includes a computer-implemented method, which may be executed by user equipment (UE). The UE, or any computing device, can be configured to perform particular operations or actions by virtue of having software, firmware, hardware, or a combination of them installed on the system that in operation causes or cause the UE to perform the actions. One or more computer programs can be configured to perform particular operations or actions by virtue of including instructions that, when executed by data processing apparatus, cause the apparatus to perform the actions. The method includes determining, by the UE, that no terrestrial access nodes are available for attaching to a wireless communication network based on a standard scanning portion (e.g., sub-algorithm) of a scanning process. The standard scanning portion may include scanning terrestrial spectrum bands of a wireless spectrum of frequencies. The terrestrial spectrum bands are associated with the terrestrial access nodes. The method further includes the UE performing a transient no coverage scanning portion of the scanning process in response to the determination. The transient no coverage scanning portion prioritizes scanning non-terrestrial spectrum bands of the wireless spectrum. The non-terrestrial spectrum bands are associated with non-terrestrial access nodes. Other embodiments of this aspect include corresponding computer systems, apparatus, and computer programs recorded on one or more computer storage devices, each configured to perform the actions of the methods.

Implementations may include one or more of the following features. Optionally, the transient no coverage scanning portion includes scanning the non-terrestrial spectrum bands for a first duration, sleeping for a second duration shorter than the first duration, scanning the terrestrial spectrum bands for a third duration shorter than the first duration, sleeping for a fourth duration shorter than the first duration, and scanning the non-terrestrial spectrum bands for the first duration a second time.

Optionally, in response to not acquiring a signal during the transient no coverage scanning portion, the UE performs a steady state no coverage portion of the scanning process. The steady state no coverage portion of the scanning process prioritizes battery life and includes scanning the non-terrestrial spectrum bands and the terrestrial spectrum bands intermittently. Optionally, the steady state no coverage portion includes scanning the non-terrestrial spectrum bands for a first duration, sleeping for a second duration longer than the first duration, and scanning the terrestrial spectrum bands for a third duration shorter than the second duration. The UE performs the steady state no coverage portion of the scanning process repeatedly until the signal is acquired.

Optionally, the method includes that in response to acquiring a signal from a non-terrestrial access node during the transient no coverage scanning portion, the UE establishes a connection via the non-terrestrial access node with the wireless communication network. Optionally, in response to establishing the connection and determining the UE is active, the UE performs a steady state active portion of the scanning process. The steady state active portion prioritizes maintaining the connection and includes scanning the terrestrial spectrum bands. Optionally, the steady state active portion includes a non-terrestrial prioritized loop. The non-terrestrial prioritized loop includes scanning the non-terrestrial spectrum bands for a first duration and sleeping for a second duration. After performing the non-terrestrial prioritized loop a predetermined number of times (e.g., 10 times), the UE scans the terrestrial spectrum bands for a third duration longer than the first duration.

Optionally, in response to establishing the connection and determining the UE is idle, the UE performs a steady state idle portion of the scanning process. The steady state idle portion prioritizes ensuring the signal is available and includes scanning the terrestrial spectrum bands. Optionally, the steady state idle portion includes a non-terrestrial prioritized loop. The non-terrestrial prioritized loop includes scanning the non-terrestrial spectrum bands for a first duration and sleeping for a second duration longer than the first duration. After performing the non-terrestrial prioritized loop a predetermined number of times (e.g., 10 times), the UE scans the terrestrial spectrum bands for a third duration longer than the first duration and the second duration. Implementations of the described techniques may include hardware, a method or process, or computer software on a computer-accessible medium.

This Summary is provided to introduce a selection of concepts in a simplified form that are further described below in the Technical Description. This Summary is not intended to identify key features or essential features of the claimed subject matter, nor is it intended to be used as an aid in determining the scope of the claimed subject matter.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an example wireless communication network environment, according to some embodiments.

FIG. 2 illustrates an example wireless spectrum having multiple spectrum bands, according to some embodiments.

FIG. 3 illustrates an example machine state flow diagram, according to some embodiments.

FIG. 4 illustrates an example transient no coverage flow, according to some embodiments.

FIG. 5 illustrates an example steady state no coverage flow, according to some embodiments.

FIG. 6 illustrates an example non-terrestrial network steady state flow for an active user equipment, according to some embodiments.

FIG. 7 illustrates an example non-terrestrial network steady state flow for an idle user equipment, according to some embodiments.

FIG. 8 illustrates an example method for improved signal acquisition of non-terrestrial signals when no terrestrial coverage is available, according to some embodiments.

FIG. 9 illustrates an operational architecture of a wireless communication network, according to some embodiments.

FIG. 10 illustrates an operational architecture for a wireless communication network, according to some embodiments.

FIG. 11 illustrates a computing system suitable for implementing the various operational environments, architectures, processes, scenarios, and sequences discussed below with respect to the other FIGS.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

As discussed above, the introduction of non-terrestrial access nodes into a wireless communication network creates challenges for user equipment (UE) that need to attach to the wireless communication network via a non-terrestrial access node. Existing scanning algorithms do not account for these challenges. Rather, existing scanning algorithms scan all terrestrial and non-terrestrial spectrum bands without distinguishing or prioritizing non-terrestrial spectrum bands under any circumstances. At present, it may be desired that a UE attach via a terrestrial access node when one is available since the cost and functional limitations associated with attaching via a non-terrestrial access node are higher. However, when a UE has no terrestrial access node options, standard scanning algorithms present issues because they often result in missed signal acquisitions.

To address these issues, techniques described herein allow a UE to execute alternative sub-algorithms a scanning algorithm that are well suited for improving signal acquisition from non-terrestrial access nodes when the UE cannot otherwise acquire a terrestrial signal. In particular, a standard portion of a scanning algorithm may be used when terrestrial signals are available. However, once the UE declares no terrestrial signals are available based on the standard portion of the scanning algorithm, the UE may execute a transitional no coverage sub-algorithm that prioritizes scanning non-terrestrial spectrum bands of the wireless spectrum. This prioritization can help ensure that if a non-terrestrial signal is available, the UE will have the best chance at acquiring the signal and attaching to the wireless network via the non-terrestrial access node (e.g., satellite).

The transitional no coverage sub-algorithm may be relatively battery intensive for the UE since scanning is a battery intensive process. Accordingly, the transitional no coverage sub-algorithm may only be executed when the UE first loses terrestrial coverage. During the transitional no coverage sub-algorithm, the UE will either acquire a terrestrial signal, acquire a non-terrestrial signal, or not acquire any signal. If a terrestrial signal is acquired, the UE returns to the standard portion of the scanning algorithm. If no signal is acquired, the UE executes a steady state no coverage algorithm that prioritizes battery life until a signal, either terrestrial or non-terrestrial, is acquired. If a terrestrial signal is acquired, the UE attaches to the wireless network by establishing a connection. The UE may be active (e.g., actively trying to receive and/or send data) or idle. If the UE is active, the UE executes an active portion of the scanning algorithm that prioritizes maintaining the connection while still scanning terrestrial spectrum bands. If the UE is idle, the UE executes an idle portion of the scanning algorithm that prioritizes ensuring the signal is available if needed while still scanning terrestrial spectrum bands. At any time a terrestrial signal is acquired, the UE returns to executing the standard portion of the scanning algorithm. At any time a non-terrestrial signal is lost, the UE executes the steady state no coverage sub-algorithm.

Advantageously, using the disclosed machine states and sub-algorithms of the scanning algorithm, the UE acquires terrestrial signals and attaches to the wireless network via terrestrial access nodes when terrestrial signals are available. However, when they are not available, the UE improves non-terrestrial signal acquisition, which reduces battery consumption. For situations where a terrestrial signal is unavailable, battery consumption may be a primary concern.

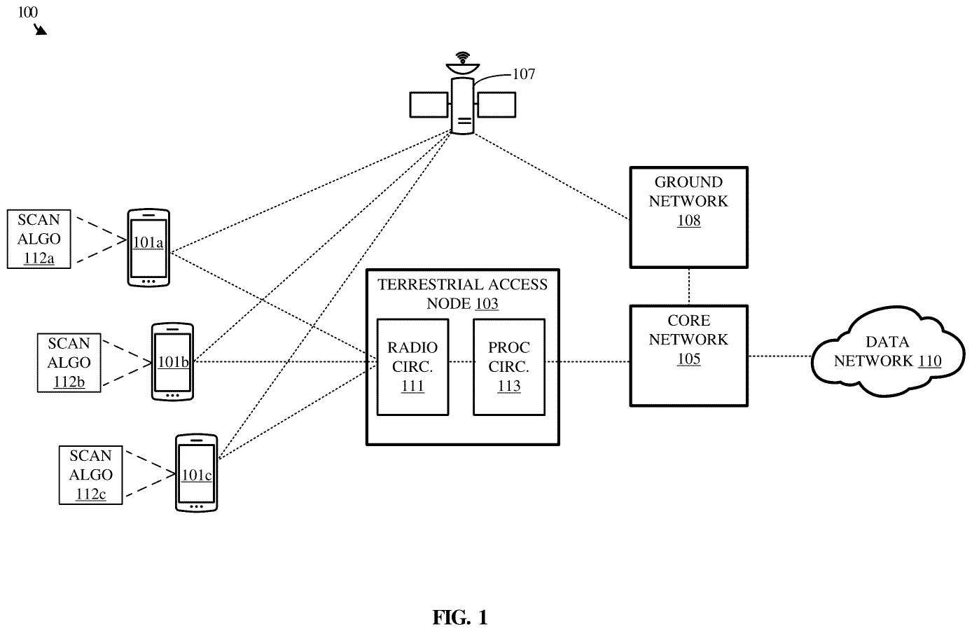

FIG. 1 illustrates an example wireless communication network environment 100 implementing the improved non-terrestrial signal acquisition techniques described above. Wireless communication network environment 100 allows UEs 101 (101a, 101b, 101c) to access services like media-streaming, media-broadcasting, internet-access, voice/video calling, text messaging, online gaming, social media, machine communications, remote device control, and/or other wireless communications products and services via core network 105 and from data network 110. Wireless communication network environment 100 includes user equipment 101, terrestrial access node 103, non-terrestrial access node 107, ground network 108, core network 105, and data network 110. In other examples, wireless communication network environment 100 may include additional or different elements than those illustrated in FIG. 1 without departing from the scope and spirit of this disclosure.

Examples of improved non-terrestrial signal acquisition are described herein. In terrestrial examples, user equipment 101 attaches to terrestrial access node 103 over radio circuitry 111 (e.g., including antennas and the like). Processing circuitry 112 in terrestrial access node 103 exchanges signaling with user equipment 101 to establish wireless data and signaling links. User equipment 101 communicates with core network 105 over terrestrial access node 103 to request wireless data services over terrestrial access node 103. User equipment 101 wirelessly exchanges user data with data network 110 over terrestrial access node 103 and core network 105.

In non-terrestrial examples, UEs 101 attach to non-terrestrial access node 107 (e.g., a satellite such as a low Earth orbit satellite) using radio circuitry (e.g., including antennas and the like, not shown). Processing circuitry (not shown) in non-terrestrial access node 107 exchanges signaling with user equipment 101 to establish wireless data and signaling links (i.e., wireless connections). User equipment 101 communicates with core network 105 over non-terrestrial access node 107 via ground network 108 to request wireless data services over non-terrestrial access node 107. As such, user equipment 101 wirelessly exchange user data with data network 110 over non-terrestrial access node 107, ground network 108, and core network 105. Accordingly, UE 101 may be able to access the same services via non-terrestrial access node 107 as UEs 101 access via terrestrial access node 103. Further, each of UEs 101 can attach to the wireless network via terrestrial access node 103 or non-terrestrial access node 107. However, the signal acquisition as described herein may differ for acquiring the signals of a terrestrial access node 103 as opposed to a non-terrestrial access node 107.

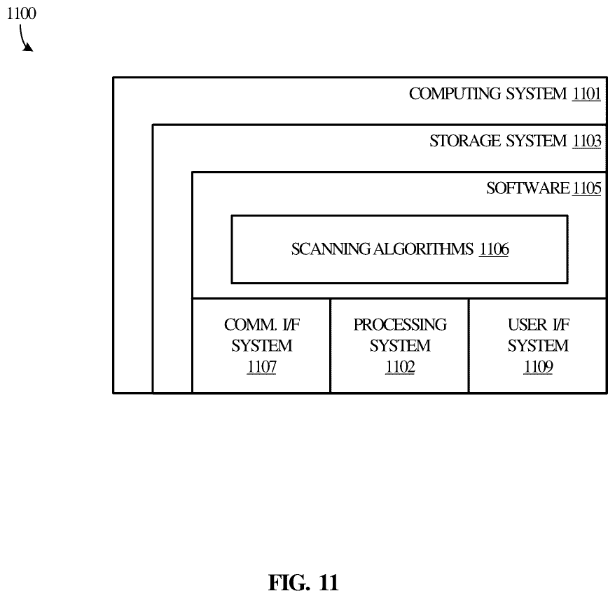

User equipment (UE) 101 may include phones, computers, vehicles, drones, robots, sensors, or other types of data appliances with wireless and/or wireline communication circuitry. UE 101 may be generally representative of a computing device such as computing device 1101 described and depicted with respect to FIG. 11. While three UE 101 are depicted in wireless communication network environment 100 for ease of depiction and description, any number of UE 101 may be in wireless communication network environment 100.

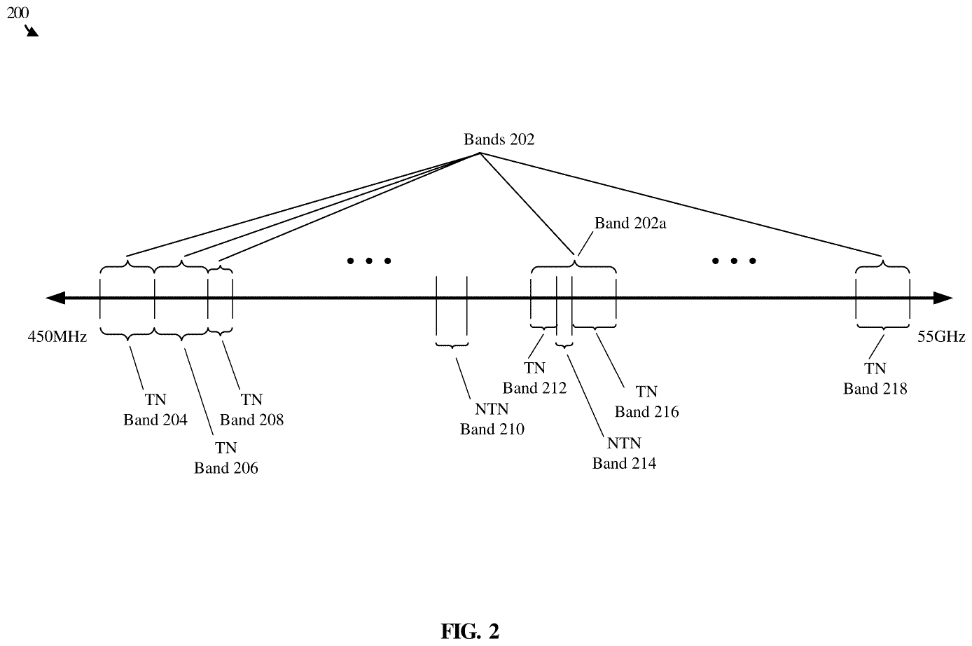

User equipment 101 each include scanning algorithm 112. User equipment 101a includes scanning algorithm 112a, user equipment 101b includes scanning algorithm 112b, and user equipment 101c includes scanning algorithm 112c. In current practice, each manufacturer of user equipment 101 may have proprietary scanning algorithms, and they may differ for each model created by the manufacturer. As an example, a GALAXY S21 manufactured by SAMSUNG may include a scanning algorithm that differs from the scanning algorithm used in a GALAXY S24 manufactured by SAMSUNG. However, due in part to regulations by the Federal Communications Commission (FCC), all scanning algorithms scan all spectrum bands of the wireless spectrum, which is described in more detail with respect to FIG. 2. As discussed herein, scanning algorithm 112a, 112b, and 112c are each an advanced scanning algorithm, according to embodiments of the present disclosure. However, in implementation, each scanning algorithm 112a, 112b, and 112c may differ slightly without departing from the scope and spirit of the present disclosure. For example, exact scanning duration values may differ while still performing the desired function. This will be discussed in further detail with respect to FIGS. 2-8. As an example, when prioritizing the non-terrestrial spectrum bands, scanning algorithm 112a may scan the non-terrestrial spectrum bands for thirty seconds while a corresponding portion of scanning algorithm 112b may scan the non-terrestrial spectrum bands for forty-five seconds. In such a case, both scanning algorithms 112a and 112b are prioritizing non-terrestrial spectrum bands but may use different durations to account for differing equipment such as antenna strength, processing power, and so forth of the respective UE. Scanning algorithms 112 are each designed to improve non-terrestrial signal acquisition when terrestrial signals are unavailable. Further, scanning algorithms 112 maintain scanning techniques to scan for terrestrial signals to ensure that when terrestrial signals are available, they are acquired and utilized.

User equipment 101 may acquire a terrestrial signal from terrestrial access node 103 using scanning algorithm 112. User equipment 101 and terrestrial access node 103 may communicate over links using wireless/wireline technologies like Sixth Generation Radio (6GR), Fifth Generation New Radio (5GNR), Long Term Evolution (LTE), Institute of Electrical and Electronic Engineers (IEEE) 802.11 (WiFi), IEEE 802.3 (Ethernet), Low-Power Wide Area Network (LP-WAN), Bluetooth, and/or some other type of wireless and/or wireline networking protocol. The wireless technologies use electromagnetic frequencies in the low-band, mid-band, high-band, or some other portion of the electromagnetic frequency wireless spectrum. The wireless spectrum is discussed in more detail with respect to FIG. 2. The wired connections include metallic links, glass fibers, and/or some other type of wired interface.

User equipment 101 may acquire a non-terrestrial signal from non-terrestrial access node 107 using scanning algorithm 112. User equipment 101 and non-terrestrial access node 107 may communicate over links using wireless technologies such as Sixth Generation Radio (6GR), Fifth Generation New Radio (5GNR), Long Term Evolution (LTE), and the like. Non-terrestrial access node 107 may be, for example, a satellite having an access node (e.g., eNodeB) modem onboard that behaves similar to a terrestrial access node (e.g., terrestrial access node 103), except in space. The access node modem may communicate with ground network 108 situated between non-terrestrial access node 107 and core network 105. Ground network 108 is depicted as separate from core network 105, however it may be incorporated into core network 105 in some embodiments. Wireless technologies use electromagnetic frequencies in the wireless spectrum, which are discussed in more detail with respect to FIG. 2.

Non-terrestrial access node 107 may include a satellite or any other space object onto which an access node modem is mounted. Non-terrestrial access node 107 may include a Sixth Generation (6G) Radio Access Network (RAN) node, Fifth Generation (5G) RAN node, LTE RAN node, gNodeB, eNodeB, or the like. In some embodiments, non-terrestrial access node 107 may be modified from terrestrial counterparts to account for the space environment including harsh conditions, reduced gravity, and the like. Other modifications may include modifications to account for signal travel distance, rapid movement, and the like. Non-terrestrial access node 107 exchanges network signaling and user data with network functions clustered together into core network 105 via ground network 108. Non-terrestrial access node 107 communicates with ground network 108, which includes circuitry and components (e.g., antennas) that establish signals with non-terrestrial access node 107 to facilitate communication with core network 105. Ground network 108 may be connected to core network 105 over one or more backhaul data links. Ground network 108 and core network 105 may communicate via edge networks like internet backbone providers, edge computing systems, or another type of edge system to provide the backhaul data and signaling links between the ground network for non-terrestrial access node 107 and core network 105.

Terrestrial access node 103 may include a tower (e.g., to mount radio circuitry 111 at elevation), another type of mounting structure (e.g., a building), or no mounting structure at all. Terrestrial access node 103 may include a Sixth Generation (6G) Radio Access Network (RAN) node, Fifth Generation (5G) RAN node, LTE RAN node, gNodeB, eNodeB, Narrow Band Internet-of-Things (NB-IoT) access node, trusted non-Third Generation Partnership Project (3GPP) access node, untrusted non-3GPP access node, Low Power-Wide Area Network (LP-WAN) base station, wireless relay, WiFi hotspot, Bluetooth access node, Ethernet access node, and/or another type of wireless or wireline network transceiver. Terrestrial access node 103 exchanges network signaling and user data with network functions clustered together into core network 105. Terrestrial access node 103 is connected to core network 105 over one or more backhaul data links. Terrestrial access node 103 and core network 105 may communicate via edge networks like internet backbone providers, edge computing systems, or another type of edge system to provide the backhaul data and signaling links between terrestrial access node 103 and core network 105.

Terrestrial access node 103 may include Radio Units (RUs), Distributed Units (DUs) and Centralized Units (CUs). For example, processing circuitry 113 may be representative of a DU and a CU while radio circuitry 111 may be representative of an RU. The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to core network 105. The CUs handle higher wireless network layers like the Radio Resource Control (RRC), Service Data Adaption Protocol (SDAP), and Packet Data Convergence Protocol (PDCP). The CUs are coupled to network functions in core network 105. Alternatively, the CUs may include RUs and Baseband Units (BBUs). The BBUs are usually nearby network computers and handle network layers like RRC, SDAP, PDCP, RLC, MAC, and PHY. The BBUs are coupled to network functions in core network 105.

Non-terrestrial access node 107 may include RUs, DUs, and CUs similar to terrestrial access node 103. In some embodiments, the DU and CU functionality may be in ground network 108. Each non-terrestrial access node 107 may include transceivers that emit multiple beams through which signals propagate to exchange data with UEs 101 and ground network 108.

Core network 105 is representative of computing systems (e.g., computing system 1101) that provide wireless data services to user equipment 101 over terrestrial access node 103 and non-terrestrial access node 107. Exemplary computing systems include Network Function Virtualization Infrastructure (NFVI) systems, data centers, server farms, cloud computing networks, hybrid cloud networks, and the like. Core network 105 may include a 3GPP core network architecture like Sixth Generation Core (6GC), Fifth Generation Core (5GC), Evolved Packet Core (EPC), and/or another type of 3GPP core network architecture. Terrestrial access node 103, non-terrestrial access node 107, ground network 108, core network 105, and data network 110 communicate over various links that use metallic links, glass fibers, radio channels, or some other communication media. The links use 6GC, 5GC, EPC, Ethernet, Time Division Multiplex (TDM), Data Over Cable System Interface Specification (DOCSIS), Internet Protocol (IP), General Packet Radio Service Transfer Protocol (GTP), 6GR, 5GNR, LTE, WiFi, virtual switching, inter-processor communication, bus interfaces, and/or some other data communication protocol. The computing systems of core network 105 store and execute the network functions/entities to form a control plane and a user plane. Exemplary control plane network functions include Access and Mobility Management Function (AMF), Session Management Function (SMF), and the like. Exemplary user plane network functions include User Plane Function (UPF) and the like.

Data network 110 includes application servers, gateways, routers, Content Distribution Networks (CNDs) and/or other communication devices to participate in data sessions with user equipment 101. For example, data network 110 may include an application server that hosts the server-side component of a user application executing on user equipment 101. Data network 110 may be representative of a public data network (e.g., the Internet) or a private data network (e.g., an enterprise network). Core network 105 and data network 110 may communicate via links provided by internet backbone providers, edge computing services, and/or other communication services that provide the data links between core network 105 and data network 110.

User equipment 101, terrestrial access node 103, non-terrestrial access node 107, and ground network 108 include antennas, amplifiers, filters, modulation, analog/digital interfaces, microprocessors, software, memories, transceivers, bus circuitry, and the like. User equipment 101, terrestrial access node 103, core network 105, non-terrestrial access node 107, ground network 108, and data network 110 may be or may include computing systems such as computing device 1101, and may also include microprocessors, software, memories, transceivers, bus circuitry, and the like. The microprocessors include Digital Signal Processors (DSP), Central Processing Units (CPU), Graphical Processing Units (GPU), Application-Specific Integrated Circuits (ASIC), Field Programmable Gate Array (FPGA), Analog Processing Units (APUs), and/or the like. The memories include Random Access Memory (RAM), Solid State Drives (SSDs), Hard Disk Drives (HDDs), Non-Volatile Memory Express (NVMe) SSDs, and/or the like. The memories store software like operating systems, user applications, radio applications, and network functions. The microprocessors retrieve the software from the memories and execute the software to drive the operation of wireless communication network environment 100 as described herein.

FIG. 2 illustrates electromagnetic spectrum 200. Electromagnetic spectrum 200 includes the span of electromagnetic frequencies available to use in wireless communication network environment 100. The depicted portion of electromagnetic spectrum 200 extends from approximately four hundred fifty Megahertz (450 MHz) to fifty-five Gigahertz (55 GHz). Electromagnetic spectrum 200 is divided into spectrum bands 202. Various spectrum bands 202 are depicted for illustrative purposes.

In the context of wireless communication network environment 100, the wireless spectrum used for wireless service refers to specific frequency ranges within the broader electromagnetic spectrum 200 that are allocated for mobile communications. These frequencies generally fall within the depicted portion of electromagnetic spectrum 200, 450 MHz-55 GHz. Electromagnetic spectrum 200 is divided into spectrum bands 202, each with its own properties, advantages, and constraints. Each spectrum band 202 includes a range of frequencies. Cellular providers use spectrum bands 202 to deliver voice, text, and data services through different generations of technology (e.g., 4G LTE, 5G NR (New Radio), 6G, and the like). Spectrum bands 202 are held by a specific carrier (e.g., T-MOBILE) for its exclusive use in a geographic area to provide wireless service to its customers.

Electromagnetic spectrum 200 is generally categorized into three main groups: low-band, mid-band, and high-band (mmWave). Low-band frequencies (e.g., 600 MHz to 1 GHz) provide broad coverage with excellent penetration through buildings and terrain. Low-band frequencies are well suited for rural areas and indoor usage. However, low-band frequencies have relatively limited bandwidth, which translates to lower data speeds. Mid-band frequencies (e.g., 1 GHz to 6 GHz, including the popular 2.5 GHz and 3.5 GHz C-band) strikes a balance between coverage and speed. Mid-band frequencies provide faster data rates than low-band while still covering a reasonably large area per access node (e.g., terrestrial access node 103). High-band frequencies (i.e., millimeter wave (mmWave)) (e.g., above 24 GHz) deliver extremely fast data rates and low latency but suffer from limited range and poor penetration through obstacles like walls and even foliage.

The advantages and disadvantages of each spectrum band 202 dictate how cellular providers (e.g., the operators of core network 105) deploy their infrastructure. Spectrum bands 202 in low-band frequencies may be useful to provide a blanket of basic coverage across large geographic areas. Spectrum bands 202 in mid-band frequencies may be used for 5G since these frequencies support good data speeds without requiring extremely dense access node placement. Spectrum bands 202 in high-band frequencies, while technically impressive, are mainly useful for dense urban environments, stadiums, and indoor hotspots where large numbers of users demand ultra-fast connections and there is line-of-sight between the transmitter and receiver (e.g., between the access node and the UE).

To prevent interference and promote fair competition, national regulatory agencies—such as the FCC in the United States—auction off spectrum bands 202 within the low-band, mid-band, and high-band frequencies to different carriers (e.g., T-MOBILE). The auctions assign exclusive rights to use the won spectrum band 202 (i.e., range of frequencies) in defined geographic areas. Some spectrum bands 202, like the unlicensed 2.4 GHz and 5 GHz used by Wi-Fi, are shared and open to anyone. Some carriers may also engage in spectrum sharing arrangements or acquire spectrum licenses from one another to consolidate their holdings and improve service.

Accordingly, carriers may hold spectrum bands 202 to cover many frequencies including spectrum bands 202 in the low-band, mid-band, and high-band frequencies. Further, once acquired, the carrier may determine how to utilize any given spectrum band 202. The carrier may deploy or utilize terrestrial access nodes, such as terrestrial access node 103, for users to utilize terrestrial signals using the frequencies, or some portion of the frequencies, in the frequency range of the given spectrum band 202. For ranges of frequencies in the given spectrum band 202 that are used for terrestrial signals via terrestrial access nodes, they are considered terrestrial network (TN) bands, such as TN band 204, 206, 208, 212, 216, and 218. Further, the carrier may deploy or utilize non-terrestrial access nodes, such as non-terrestrial access node 107, for users to utilize non-terrestrial signals using the frequencies, or some portion of the frequencies, in the frequency range of the given spectrum band 202. For ranges of frequencies in the given spectrum band 202 that are used for non-terrestrial signals via non-terrestrial access nodes, they are considered non-terrestrial network (NTN) bands, such as NTN band 210 and 214. As shown by spectrum band 202a, the carrier may divide the spectrum band to create TN bands and NTN bands within a given spectrum band. As used throughout, TN bands (e.g., TN band 204, 206, 208, 212, 216, and 218) may be referred to as terrestrial spectrum bands, TN spectrum bands, TN bands, or the like, and NTN bands (e.g., NTN band 210, 214) may be referred to as non-terrestrial spectrum bands, NTN spectrum bands, NTN bands, or the like.

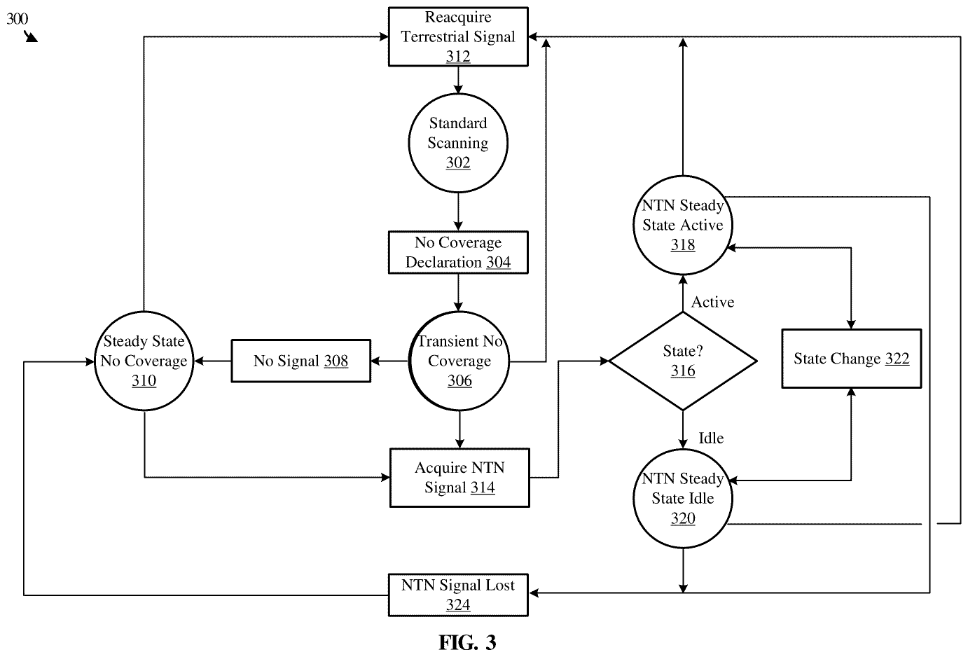

While attempting to attach to a wireless network, a UE may scan all available bands 202 in electromagnetic spectrum 200. The available bands 202 may include only those bands associated with wireless carriers. However, during scanning, the UE may acquire signals that are not usable, for example, because the carrier through which the UE has access may not be the carrier to which the particular spectrum band 202 is assigned. For example, carrier A may hold TN band 204, carrier B may hold TN band 206, and carrier C may hold TN band 208. A UE associated with carrier C (i.e., having coverage through carrier C) may start up. The scanning algorithm (e.g., scanning algorithm 112) may perform a standard scanning portion (e.g., standard scanning portion 302 described with respect to FIG. 3) and first acquire a signal from a terrestrial node (e.g., terrestrial node 103) emitting a signal with a frequency in TN band 204. The UE may attempt to attach, but the attempt will be rejected because the UE does not have coverage through carrier A, which holds TN band 204. Similarly, a signal acquired from a terrestrial node emitting a signal with a frequency in TN band 206 will also be rejected. However, when the UE acquires a signal with a frequency in TN band 208, held by carrier C through which the UE has coverage, the request will be accepted, and the UE will be able to attach to the wireless network. Additional functions within the scanning algorithm may help the UE attach or maintain the attachment to the wireless network efficiently. For example, the UE may continue to perform the scanning algorithm and find a stronger signal that better serves the UE. In cases in which the UE is already attached to the wireless network but finds a better signal, the access nodes may perform a handover so that the UE has a better connection to the wireless network without losing connectivity.

The scanning algorithm on the UE may be performed constantly or periodically such that the UE maintains a connection to the wireless network as long as a signal is available. Further, the scanning algorithm may scan all the available spectrum bands 202 to ensure that in an emergency, the UE can connect to any available spectrum band 202 regardless of carrier to perform an emergency (e.g., 911, 999, 112, and so forth) call, though the regulations requiring such functionality may vary by jurisdiction. Accordingly, while performing the scanning algorithm, the UE may scan NTN bands (e.g., NTN band 210, 214) similarly to how it scans TN bands (e.g., TN band 204, 206, 208, 212, 216, 218). However, as discussed above, attaching to an NTN access node may be more difficult and therefore may take additional time to acquire the signal and attach to the network. Scanning algorithm 112 accounts for such difficulty.

FIG. 3 illustrates an example flow 300 of a scan algorithm. Flow 300 may be generally representative of the flow of scanning algorithm 112 as described with respect to FIG. 1. The scanning algorithm may be embodied in executable instructions stored on a memory of a computing device (e.g., a UE) that are read and executed by one or more processors to perform the instructions, causing the computing device to perform the described functions. Flow 300 depicts an example flow of how a scanning algorithm may include portions (i.e., sub-algorithms) of the scanning algorithm and how the scanning algorithm may move between the portions. For example, the scanning algorithm may include standard scanning portion 302, transient no coverage portion 306, steady state no coverage portion 310, NTN steady state active portion 318, and NTN steady state idle portion 320, each of which may be sub-algorithms of the scanning algorithm. Flow 300 may include other sub-algorithms, in some embodiments, without departing from the scope and spirit of the present disclosure.

Standard scanning portion 302 may be any scanning sub-algorithm used by the UE during circumstances in which a terrestrial signal is readily available, was readily available, or at initial startup of the UE. As used herein, a terrestrial signal is a signal from a terrestrial access node (e.g., terrestrial access node 103) and is also sometimes described as a terrestrial network (TN) or a TN signal. A non-terrestrial signal is a signal from a non-terrestrial access node (e.g., non-terrestrial access node 107) and is also sometimes described as a non-terrestrial network (NTN) or NTN signal.

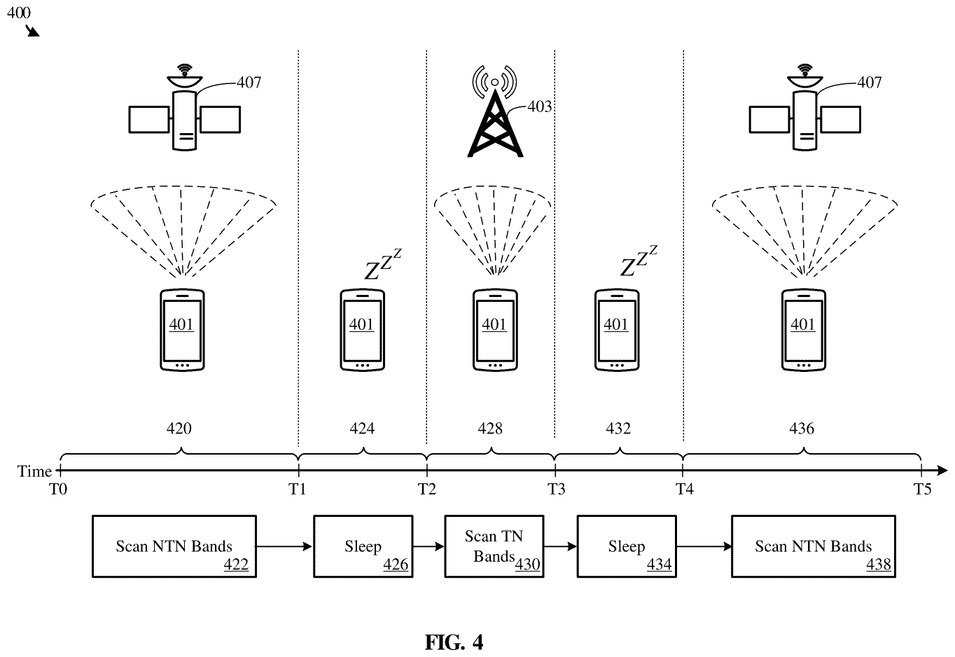

Standard scanning portion 302 may be executed by the UE until no terrestrial signal can be acquired. Based on a determination made during standard scanning portion 302, the UE may declare or determine no terrestrial coverage is available, depicted as no coverage declaration 304. Upon determining no terrestrial coverage is available, the UE may execute transient no coverage portion 306. In transient no coverage portion 306, the UE may prioritize scanning non-terrestrial spectrum bands (e.g., NTN bands 210, 214). For example, the UE may scan NTN bands for a longer duration, more often, or the like to ensure the UE scans NTN bands for a sufficient duration to acquire available signals. This prioritization is balanced with the need to maintain scanning for TN bands as well as maintaining battery life. An example transient no coverage portion 306 is discussed with respect to FIG. 4.

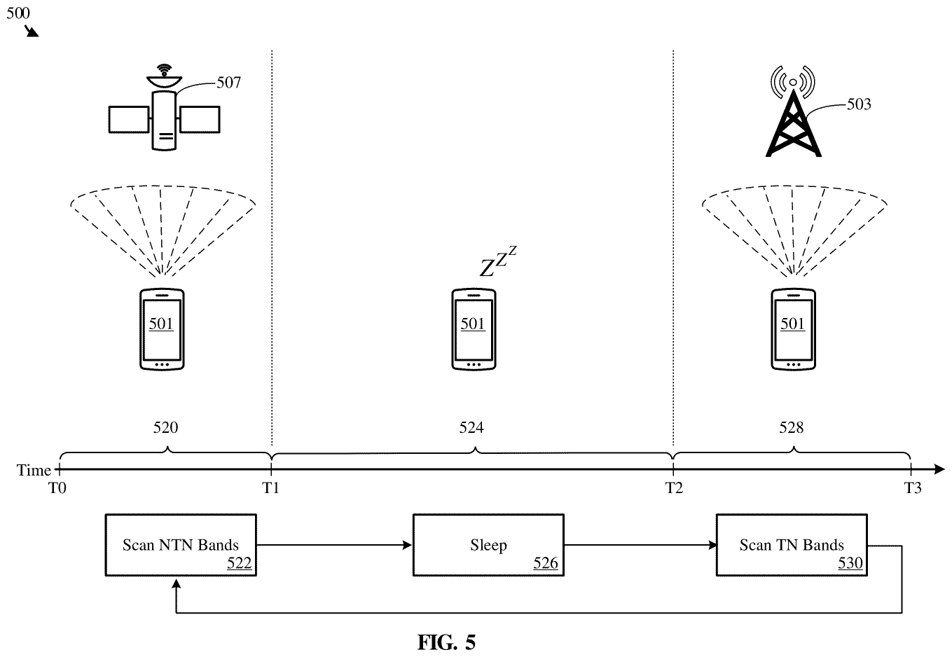

Transient no coverage portion 306 may be executed once, multiple times, for a specified duration, or the like or until a signal is acquired. If a TN signal is acquired, as during any portion of flow 300, the UE determines the TN signal is acquired, depicted as reacquire terrestrial signal 312, and the UE returns to standard scanning portion 302. If no signal is acquired during execution of transient no coverage portion 306, the UE determines no signal is available, depicted as no signal 308. Upon determining no signal is available, the UE may execute steady state no coverage portion 310. In steady state no coverage portion 310, the UE may prioritize battery life while still scanning both NTN bands and TN bands. In a scenario when a UE cannot obtain or acquire a signal, battery life of the UE becomes a concern. Further, scanning for signals is a battery drain. Under circumstances when signals are available, scanning takes less battery because the scanning stops prior to the timeout period due to signal acquisition. When no signal is available, the UE scans bands (e.g., spectrum bands 202) the entire duration of the timeout period, draining the battery. Accordingly, steady state no coverage portion 310 includes longer sleep periods (i.e., no scanning periods) while also scanning TN bands and NTN bands. Further, the NTN band scanning may be performed separately, which helps improve the ability of the UE to acquire the NTN signals. Steady state no coverage portion 310 may be executed in a loop until the battery is exhausted (i.e., the UE powers down) or a signal is acquired, which may be either a TN signal or an NTN signal. An example steady state no coverage portion 310 is discussed with respect to FIG. 5.

If, during steady state no coverage portion 310, a TN signal is acquired, the UE returns to standard scanning portion 302 due to determining the TN signal is acquired at reacquire TN signal 312. If an NTN signal is acquired either during steady state no coverage portion 310 or transient no coverage portion 306, the UE determines an NTN signal is acquired, depicted as acquire NTN signal 314.

Upon acquiring the NTN signal, the UE determines the state of the UE at state 316. The UE may be active or idle, depending on whether there is an active attempt to use data or voice functionality at the time. If the UE is active, it executes NTN steady state active portion 318, and if the UE is idle, it executes NTN steady state idle portion 320. At any time the state of the UE changes, which is determined by the UE based on active requests, a timeout period of no activity, or the like, the UE may switch between NTN steady state active portion 318 and NTN steady state idle portion 320. Further, at any point a TN signal is acquired during execution of either portion, the UE determines reacquire terrestrial signal 312 and returns to standard scanning portion 302. Additionally, at any point the NTN signal is lost, the UE determines NTN signal lost 324 and returns to executing steady state no coverage portion 310.

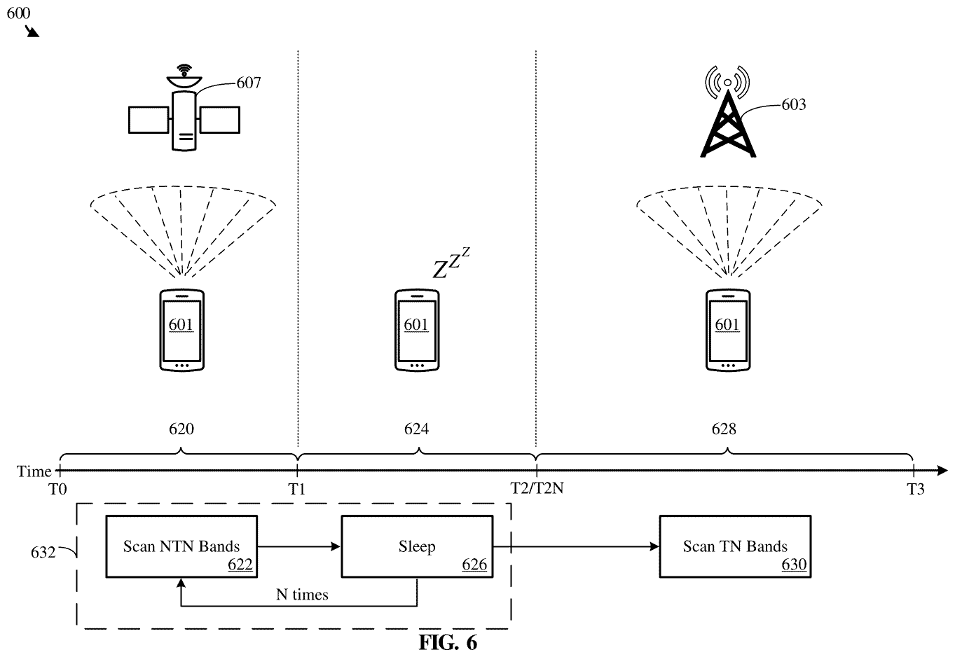

NTN steady state active portion 318 may prioritize maintaining the NTN connection to the wireless network while still scanning for TN signals. NTN steady state active portion 318 may be performed one or more times, for example, and if no signal is detected, the UE may determine NTN signal lost 324. An example NTN steady state active portion 318 is discussed with respect to FIG. 6.

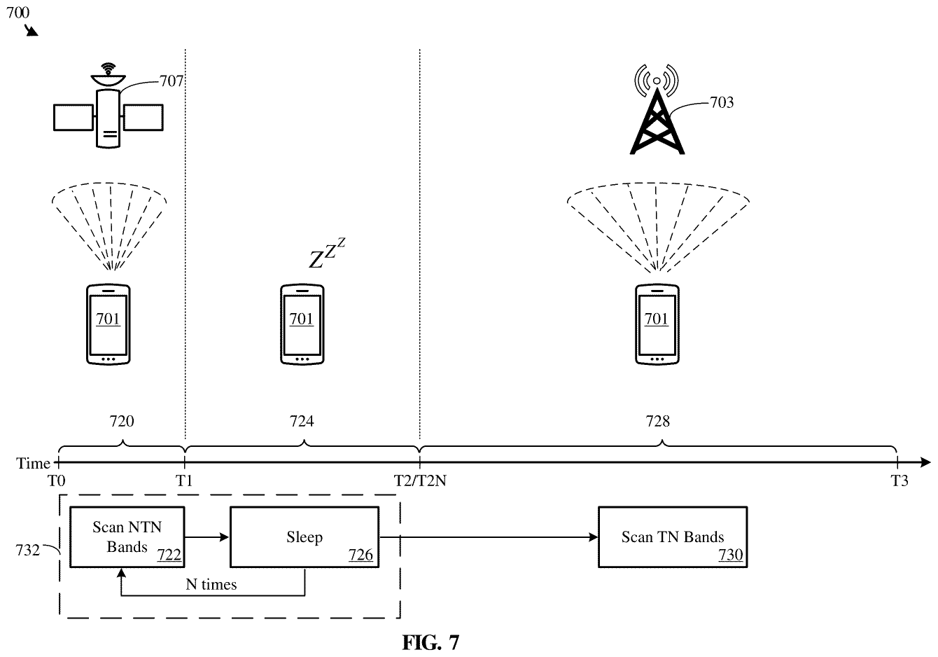

NTN steady state idle portion 320 may prioritize ensuring the NTN connection to the wireless network remains available while still scanning for TN signals. NTN steady state idle portion 320 may be performed one or more times, for example, and if no signal is detected, the UE may determine NTN signal lost 324. An example NTN steady state idle portion 320 is discussed with respect to FIG. 7.

Advantageously, the scanning algorithm executed by the UE ensures that when a TN signal is available, it is utilized. NTN signal acquisition is improved when TN signals are not available, and battery life is extended. While conditions may change in the future, at present, using a TN signal to attach to a wireless network is superior to attaching via an NTN signal due to cost, limitations in functionality, and the like. However, when no TN signal is available, attaching via an NTN signal is superior to having no signal available. Since acquiring an NTN signal is more difficult than acquiring a TN signal due to the speed that NTN access nodes are moving and associated constantly changing parameters for connection, longer scanning durations and specifically scanning NTN bands improves signal acquisition when no TN signals are available. Accordingly, the described sub-algorithms that take into account the state of the circumstances and adjust appropriately balance improving NTN signal acquisition, using TN signals when available, and extending battery life of the UE.

FIG. 4 illustrates an example transient no coverage sub-algorithm 400 (e.g., transient no coverage portion 306). As discussed with respect to FIG. 3, transient no coverage sub-algorithm 400 may be performed one or more times or for a specified duration and is designed to prioritize acquiring NTN signals. When transient no coverage sub-algorithm 400 is executed, the UE has declared no coverage, meaning that using the standard scanning portion of the scanning algorithm, the UE has been unable to acquire a signal. Since standard scanning does not prioritize acquiring NTN signals, and since NTN signals are sometimes difficult to initially acquire, the UE executes transient no coverage sub-algorithm 400 to give the UE an extra opportunity to acquire an NTN signal. At any time a signal is acquired, transient no coverage sub-algorithm 400 may exit. Transient no coverage sub-algorithm 400 includes a timeline with times T0-T5, UE 401, NTN access node 407, and TN access node 403. UE 401 may be generally representative any UE such as UE 101 executing scanning algorithm 112, NTN access node 407 may be generally representative of any NTN access node such as NTN access node 107, and TN access node 403 may be generally representative of any TN access node such as TN access node 103.

During step 422, starting at time T0 and for duration 420 (i.e., until time T1), UE 401 scans NTN bands (e.g., NTN bands 210, 214, and so forth), which have frequencies on which NTN access node 407 emits signals. Because NTN band scanning is prioritized, duration 420 may be a relatively long period, though it may not be so long as to drain the battery of UE 401. Accordingly, duration 420 may be, for example, between 15 seconds and two minutes. If no NTN signal is acquired, UE 401 moves to step 426.

At step 426, starting at time T1 and for duration 424 (i.e., until time T2), UE 401 sleeps (i.e., does not scan TN bands or NTN bands). Duration 424 may be included to help ensure NTN access nodes 407 may move within range of UE 401 and maintain battery life for UE 401. Accordingly, duration 424 may be, for example, between one second and one minute. Further, duration 424 may be less than duration 420.

At step 430, starting at time T2 and for duration 428 (i.e., until time T3), UE 401 scans TN bands (e.g., TN bands 204, 206, 208, and so forth), which have frequencies on which TN access node 403 emits signals. Because NTN band scanning is prioritized, duration 428 may be a relatively short period, though it may be long enough to help ensure TN signal acquisition if a TN signal is available. Accordingly, duration 428 may be, for example, between five seconds and one minute. Further, duration 428 may be less than duration 420. If no TN signal is acquired, UE 401 moves to step 434.

At step 434, starting at time T3 and for duration 432 (i.e., until time T4), UE 401 sleeps. Duration 432 may be included to help ensure NTN access nodes 407 may move within range of UE 401 and maintain battery life for UE 401. Accordingly, duration 432 may be, for example, between one second and one minute. Further, duration 432 may be less than duration 420. In some embodiments, duration 432 is the same as duration 424.

At step 438 starting at time T4 and for duration 436 (i.e., until time T5), UE 401 scans NTN bands, which have frequencies on which NTN access node 407 emits signals. Step 438 may be another relatively lengthy duration for which UE 401 has improved ability to acquire an NTN signal from NTN access node 407. Accordingly, duration 436 may be a relatively long period, though it may not be so long as to drain the battery of UE 401. Accordingly, duration 436 may be, for example, between 15 seconds and two minutes. Duration 436 may be the same as duration 420 in some embodiments. However, in some embodiments, duration 436 may be longer than duration 420. If no NTN signal is acquired, UE 401 may exit transient no coverage sub-algorithm 400.

As one example of durations of transient no coverage sub-algorithm 400, duration 420 may be one minute, duration 424 may be 30 seconds, duration 428 may be 30 seconds, duration 432 may be 30 seconds, and duration 436 may be one minute. In other words, in this example, UE 401 may scan NTN bands for one minute, sleep for 30 seconds, scan TN bands for 30 seconds, sleep for 30 seconds, and scan NTN bands again for one minute. The total duration of transient no coverage sub-algorithm 400 in this example is 3.5 minutes, which allows UE 401 extensive opportunity to acquire an NTN signal and reasonable opportunity to acquire a TN signal while maintaining battery life of UE 401 because it is executing thorough scanning for a limited time.

FIG. 5 illustrates an example steady state no coverage sub-algorithm 500 (e.g., steady state no coverage portion 310). As discussed with respect to FIG. 3, steady state no coverage sub-algorithm 500 may be performed repeatedly until a signal is acquired and is designed to prioritize battery life. When steady state no coverage sub-algorithm 500 is executed, the UE has declared no coverage based on the standard scanning portion of the scanning algorithm and has not been able to acquire a signal using transient no coverage sub-algorithm 400. Since scanning is battery intensive, and since NTN signals are more difficult to initially acquire than TN signals, UE 501 executes steady state no coverage sub-algorithm 500 to give the UE reasonable opportunity to acquire either TN or NTN signals while extending battery life. At any time a signal is acquired, steady state no coverage sub-algorithm 500 may exit. Steady state no coverage sub-algorithm 500 includes a timeline with times T0-T3, UE 501, NTN access node 507, and TN access node 503. UE 501 may be generally representative of any UE such as UE 101, 401 executing scanning algorithm 112, NTN access node 507 may be generally representative of any NTN access node such as NTN access node 107, 407, and TN access node 503 may be generally representative of any TN access node such as TN access node 103, 403.

During step 522, starting at time T0 and for duration 520 (i.e., until time T1), UE 501 scans NTN bands (e.g., NTN bands 210, 214, and so forth), which have frequencies on which NTN access node 507 emits signals. Because battery life is prioritized, duration 520 may be a relatively short period, though it may be long enough to help ensure NTN signal acquisition if an NTN signal is available. Accordingly, duration 520 may be, for example, between one second and 30 seconds. If no NTN signal is acquired, UE 501 moves to step 526.

At step 526, starting at time T1 and for duration 524 (i.e., until time T2), UE 501 sleeps (i.e., does not scan TN bands or NTN bands). Duration 524 is included to prioritize battery life for UE 501 and is accordingly a relatively long period. Accordingly, duration 524 may be, for example, between five seconds and one minute. Further, duration 524 may be greater than duration 520.

At step 530, starting at time T2 and for duration 528 (i.e., until time T3), UE 501 scans TN bands (e.g., TN bands 204, 206, 208, and so forth), which have frequencies on which TN access node 503 emits signals. Because battery life is prioritized, duration 528 may be a relatively short period, though it may be long enough to help ensure TN signal acquisition if a TN signal is available. Accordingly, duration 528 may be, for example, between five seconds and 30 seconds. Further, duration 528 may be less than duration 524. In some embodiments, duration 528 may be less than 520 since acquiring a TN signal is typically easier than acquiring an NTN signal. However, having fewer NTN bands to scan than TN bands may be reason to justify a relatively similar duration of duration 520 and duration 528 or even a longer duration for duration 528 than duration 520. If no TN signal is acquired, UE 501 repeats steady state no coverage sub-algorithm 500.

As one example of durations of steady state no coverage sub-algorithm 500, duration 520 may be 10 seconds, duration 524 may be 30 seconds, and duration 528 may be 15 seconds. In other words, in this example, UE 501 may scan NTN bands for 10 seconds, sleep for 30 seconds, and scan TN bands for 15 seconds. The total duration of steady state no coverage sub-algorithm 500 in this example is 55 seconds, and the total time UE 501 scans is 25 seconds, which allows UE 501 sufficient opportunity to acquire any type (NTN or TN) of signal while prioritizing battery life of UE 501.

FIG. 6 illustrates an example NTN steady state active sub-algorithm 600 (e.g., NTN steady state active portion 318). As discussed with respect to FIG. 3, NTN steady state active sub-algorithm 600 may be performed while the UE is active and an NTN signal was acquired. It is designed to maintain the connection to the wireless network through the NTN access nodes while still checking for TN signals. When NTN steady state active sub-algorithm 600 is executed, the UE has acquired an NTN signal and determined the UE is active. Maintaining an NTN signal may not be as difficult as initially acquiring the signal since handovers may be performed to help ensure the UE does not lose connectivity, so the duration of scanning to maintain an NTN signal may be shorter than the duration for initial acquisition, which helps maintain battery life. At any time a signal is acquired, steady state active sub-algorithm 600 may exit. Steady state active sub-algorithm 600 includes a timeline with times T0-T3, UE 601, NTN access node 607, and TN access node 603. UE 601 may be generally representative of any UE such as UE 101, 401, 501 executing scanning algorithm 112, NTN access node 607 may be generally representative of any NTN access node such as NTN access node 107, 407, 507, and TN access node 603 may be generally representative of any TN access node such as TN access node 103, 403, 503.

During step 622, starting at time T0 and for duration 620 (i.e., until time T1), UE 601 scans NTN bands (e.g., NTN bands 210, 214, and so forth), which have frequencies on which NTN access node 607 emits signals. Duration 620 may be a relatively short period to maintain battery life, though it may be long enough to help ensure the NTN connection is maintained. Accordingly, duration 620 may be, for example, between five seconds and 30 seconds. If no NTN signal is acquired, UE 601 moves to step 626.

At step 626, starting at time T1 and for duration 624 (i.e., until time T2), UE 601 sleeps (i.e., does not scan TN bands or NTN bands). Duration 624 is included to help maintain battery life for UE 601 and to ensure NTN access nodes 607 have time to come into range of UE 601. Accordingly, duration 624 may be, for example, between one second and 30 seconds. Further, duration 624 may be less than duration 620.

Scan NTN bands 622 and sleep 626 may form NTN prioritized loop 632. NTN prioritized loop 632 may execute a predetermined number of times (i.e., N times). The number of times may be any suitable number to prioritize maintaining the NTN connection to the wireless network, for example between 5 and 15 times. Once NTN prioritized loop 632 executes the given number of times, at time T2N, UE 601 moves to step 630 to scan TN bands.

At step 630, starting at time T2N and for duration 628 (i.e., until time T3), UE 601 scans TN bands (e.g., TN bands 204, 206, 208, and so forth), which have frequencies on which TN access node 603 emits signals. To ensure there is sufficient opportunity to acquire TN signals, duration 628 may be a relatively long period as compared to duration 620, since scan TN bands 630 may be performed only once. Accordingly, duration 628 may be, for example, between five seconds and 20 seconds. If no TN signal is acquired, UE 601 exits NTN steady state active sub-algorithm 600 and may return to steady state no coverage sub-algorithm 500 as depicted in FIG. 3.

As one example of durations of NTN steady state active sub-algorithm 600, duration 620 may be five seconds, duration 624 may be five seconds, and duration 628 may be 15 seconds. NTN prioritized loop may execute 10 times. In other words, in this example, UE 601 may scan NTN bands for 5 seconds and sleep for 5 seconds and repeat this 10 times. Upon not detecting an NTN signal during any iteration, UE 601 scans TN bands for 15 seconds. The total duration of NTN steady state active sub-algorithm 600 in this example is 115 seconds, and the total time UE 601 scans is 65 seconds, which allows UE 601 prioritized opportunity to maintain the NTN connection and sufficient opportunity to acquire a TN signal while using reasonable battery life of UE 601.

FIG. 7 illustrates an example NTN steady state idle sub-algorithm 700 (e.g., NTN steady state idle portion 320). As discussed with respect to FIG. 3, NTN steady state idle sub-algorithm 700 may be performed while the UE is idle and an NTN signal was acquired. It is designed to ensure an NTN signal is available if needed while still checking for TN signals. When NTN steady state idle sub-algorithm 700 is executed, the UE has acquired an NTN signal and determined the UE is idle. Ensuring the NTN signal remains available may not be as difficult as initially acquiring the signal since handovers may be performed to help ensure the UE does not lose connectivity and once the NTN signal is acquired the first time there is reason to believe it may be there again on the next scan, so the duration of scanning to ensure an NTN signal remains available may be shorter than the duration for initial acquisition, which helps maintain battery life. At any time a signal is acquired, NTN steady state idle sub-algorithm 700 may exit. NTN steady state idle sub-algorithm 700 includes a timeline with times T0-T3, UE 701, NTN access node 707, and TN access node 703. UE 701 may be generally representative of any UE such as UE 101, 401, 501, 601 executing scanning algorithm 112, NTN access node 707 may be generally representative of any NTN access node such as NTN access node 107, 407, 507, 607, and TN access node 703 may be generally representative of any TN access node such as TN access node 103, 403, 503, 603.

During step 722, starting at time T0 and for duration 720 (i.e., until time T1), UE 701 scans NTN bands (e.g., NTN bands 210, 214, and so forth), which have frequencies on which NTN access node 707 emits signals. Duration 720 may be a relatively short period to maintain battery life, though it may be long enough to help ensure the NTN signal is still available. Accordingly, duration 720 may be, for example, between one second and 30 seconds. If no NTN signal is acquired, UE 701 moves to step 726.

At step 726, starting at time T1 and for duration 724 (i.e., until time T2), UE 701 sleeps (i.e., does not scan TN bands or NTN bands). Duration 724 is included to help maintain battery life for UE 701 and to ensure NTN access nodes 707 have time to come into range of UE 701. Accordingly, duration 724 may be, for example, between five seconds and 30 seconds. Further, duration 624 may be longer than duration 720 since UE 701 is idle.

Scan NTN bands 722 and sleep 726 may form NTN prioritized loop 732. NTN prioritized loop 732 may execute predetermined a number of times (i.e., N times). The number of times may be any suitable number to prioritize maintaining the NTN connection to the wireless network, for example between 5 and 15 times. Once NTN prioritized loop 732 executes the given number of times, until time T2N, UE 701 moves to step 730 to scan TN bands.

At step 730, starting at time T2N and for duration 728 (i.e., until time T3), UE 701 scans TN bands (e.g., TN bands 204, 206, 208, and so forth), which have frequencies on which TN access node 703 emits signals. To ensure there is sufficient opportunity to acquire TN signals, duration 728 may be a relatively long period as compared to duration 720, since scan TN bands 730 may be performed only once. Accordingly, duration 728 may be, for example, between one second and 20 seconds. If no TN signal is acquired, UE 701 exits NTN steady state idle sub-algorithm 700 and may return to steady state no coverage sub-algorithm 500 as depicted in FIG. 3.

As one example of durations of NTN steady state idle sub-algorithm 700, duration 720 may be one second, duration 724 may be five seconds, and duration 728 may be 15 seconds. NTN prioritized loop 732 may execute 10 times. In other words, in this example, UE 701 may scan NTN bands for one second and sleep for 5 seconds and repeat this 10 times. Upon not detecting an NTN signal during any iteration, UE 701 scans TN bands for 15 seconds. The total duration of NTN steady state idle sub-algorithm 700 in this example is 75 seconds, and the total time UE 701 scans is 25 seconds, which allows UE 701 prioritized opportunity to maintain the NTN connection and sufficient opportunity to acquire a TN signal while using reasonable battery life of UE 701.

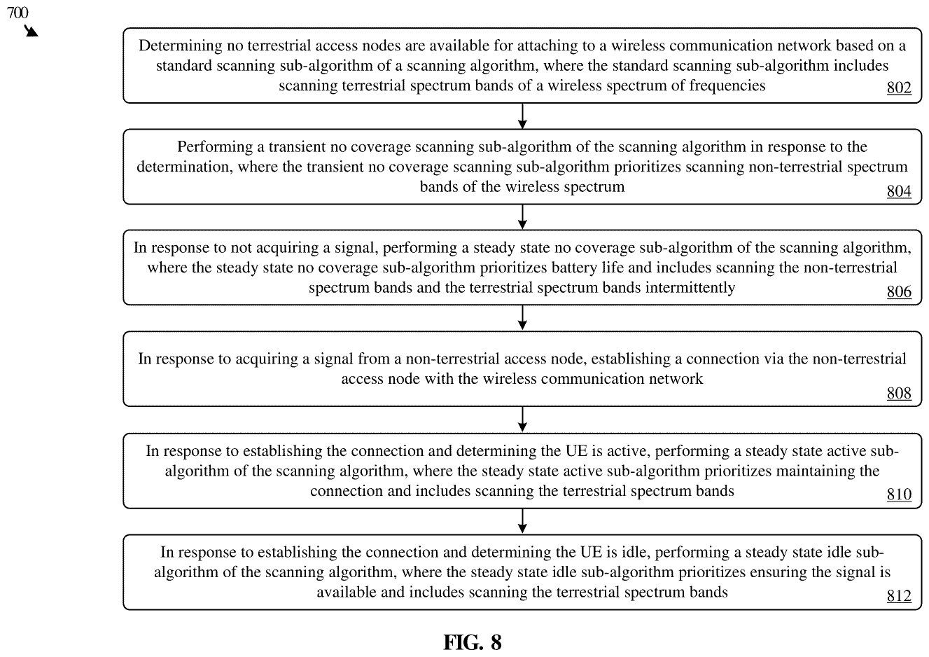

FIG. 8 illustrates method 800 for improved NTN signal acquisition in no TN signal coverage areas. Method 800 may be performed by a UE such as UE 101, 401, 501, 601, 701. Method 800 may include more or fewer steps than depicted, and the steps of method 800 may be performed in a different order without departing from the scope and spirit of this disclosure.

Method 800 begins with step 802 in which the UE determines no terrestrial access nodes are available for attaching to a wireless communication network based on a standard scanning sub-algorithm of a scanning algorithm, wherein the standard scanning sub-algorithm scans terrestrial spectrum bands of a wireless spectrum of frequencies. For example, the UE may execute standard scanning portion 302 of the scanning algorithm. In standard scanning portion 302, the UE may scan TN bands (e.g., TN bands 204, 206, 208, 212, and so forth). The standard scanning sub-algorithm may prioritize scanning the TN bands but may also scan the NTN bands in some embodiments. Upon not detecting any signals during the standard scanning sub-algorithm, the UE may declare no coverage or no signal is available (no coverage declaration 304).

In response to the no coverage declaration, the UE performs a transient no coverage scanning sub-algorithm of the scanning algorithm (step 804). The transient no coverage scanning sub-algorithm prioritizes scanning non-terrestrial spectrum bands of the wireless spectrum. For example, the UE executes transient no coverage portion 306 and prioritizes scanning the NTN bands (e.g., NTN bands 210, 214). An example of a transient no coverage sub-algorithm is depicted with respect to FIG. 4.

In response to not acquiring a signal (TN or NTN) in step 804, the UE performs step 806. In step 806, the UE performs a steady state no coverage sub-algorithm of the scanning algorithm. The steady state no coverage sub-algorithm prioritizes battery life and scans the non-terrestrial spectrum bands and the terrestrial spectrum bands intermittently. For example, upon determining no signal (no signal 308), the UE executes steady state no coverage portion 310, which scans NTN bands (e.g., NTN bands 210, 214) and TN bands (e.g., TN bands 204, 204, and so forth). An example of a steady state no coverage sub-algorithm is depicted with respect to FIG. 5. However, in an alternative scenario, the transient no coverage scanning sub-algorithm may acquire an NTN signal in step 804, such as a signal from a non-terrestrial access node.

In response to acquiring a signal from a non-terrestrial access node (e.g., during transient no coverage scanning sub-algorithm in step 804 or during steady state no coverage sub-algorithm in step 806), the UE may establish a connection via the non-terrestrial access node with the wireless communication network at step 808. For example, the UE may attach to the wireless network via the NTN access node.

At step 810, in response to establishing the connection and determining the UE is active, the UE performs a steady state active sub-algorithm of the scanning algorithm. The steady state active sub-algorithm prioritizes maintaining the connection and scans the terrestrial spectrum bands. Since the UE is active, which means it is actively or may be actively attempting to utilize voice or data functionality through the wireless network, the UE prioritizes maintaining the NTN connection. For example, the UE executes NTN steady state active portion 318 to scan NTN bands and TN bands. An example of an NTN steady state active sub-algorithm is depicted with respect to FIG. 6.

At step 812, in response to establishing the connection and determining the UE is idle, the UE performs a steady state idle sub-algorithm of the scanning algorithm. The steady state idle sub-algorithm prioritizes ensuring the NTN signal is available and scans the terrestrial spectrum bands. Since the UE is idle, which means it is not actively attempting to utilize voice or data functionality through the wireless network, the UE prioritizes ensuring the NTN signal is available. For example, the UE executes NTN steady state idle portion 320 to scan NTN bands and TN bands. An example of an NTN steady state idle sub-algorithm is depicted with respect to FIG. 7.

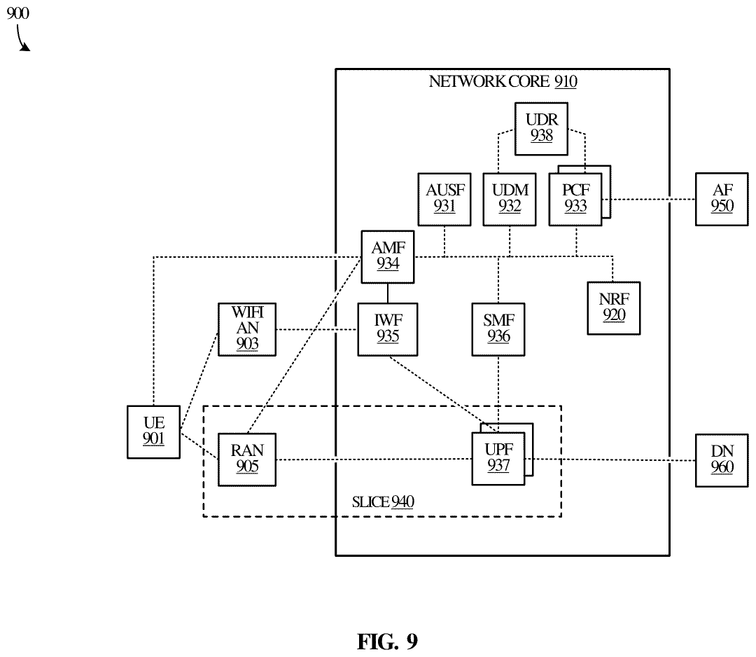

FIG. 9 illustrates exemplary wireless communication system 900 that serves wireless User Equipment (UE) 901. Wireless communication system 900 may be an implementation of wireless communication network environment 100. Accordingly, wireless communication system 900 depicts additional details of functionality included in wireless communication network environment 100. Wireless communication system 900 includes UE 901, Wifi Access Node (AN) 903, 5GNR RAN 905, Interworking Function (IWF) 935, Access and Mobility Management Function (AMF) 934, Authentication Server Function (AUSF) 931, Unified Data Management (UDM) 932, Policy Control Functions (PCFs) 933, Session Management Function (SMF) 936, User Plane Function (UPF) 937, Uniform Data Repository (UDR) 938, and Application Function (AF) 950. UE 901 may be representative of one of user equipment 101, Wifi AN 903 may be representative of terrestrial access node 103, radio access node (RAN) 905 may be representative of non-terrestrial access node 107, network core 910 may be representative of core network 105, and data network 960 may be representative of data network 110.

UDR 938 stores network data including subscriber profiles including identities, subscription details, service preferences, authentication credentials, and billing information. UDR 938 may also store policy data such as network rules, access rules, mobility rules, charging rules, and so on. AF 950 may provide policies applicable to control plane functions, that is, to the application, presentation, and/or session layers of the OSI protocol stack. IWF 935 includes non-3GPP IWFs (N3IWFs) for providing untrusted non-3GPP access to network core 910 (e.g., a network data center), such as access via a non-cellular access network.

Continuing with wireless communication system 900, wireless network slice 940 includes UPF 937 and SMF 936. Wireless network slice 940 may be representative of a dynamically allocated slice of finite duration selected for hosting service from DN 960 to UE 901. DN 960 is representative of a data network, Internet access, third-party resource, or other endpoint of an end-to-end communication path from UE 901. For example, DN 960 may be an application or application service for the wireless network of network core 910 for service to UE 901.

In an implementation, UE 901 communicates with network core 910 via radio access node (e.g., 5G-NR access node) 905 or Wifi access node 903. UE 901 requests access to DN 960 via the communication network of network data center 710, e.g., via wireless network slice 940. SMF 936 receives the access request from AMF 934 and other network functions of the communication network which are enforcing various aspects of the access request from UE 901. SMF 936 receives policies or policy decisions from AUSF 931, UDM 932, PCF 933, and/or AMF 934.

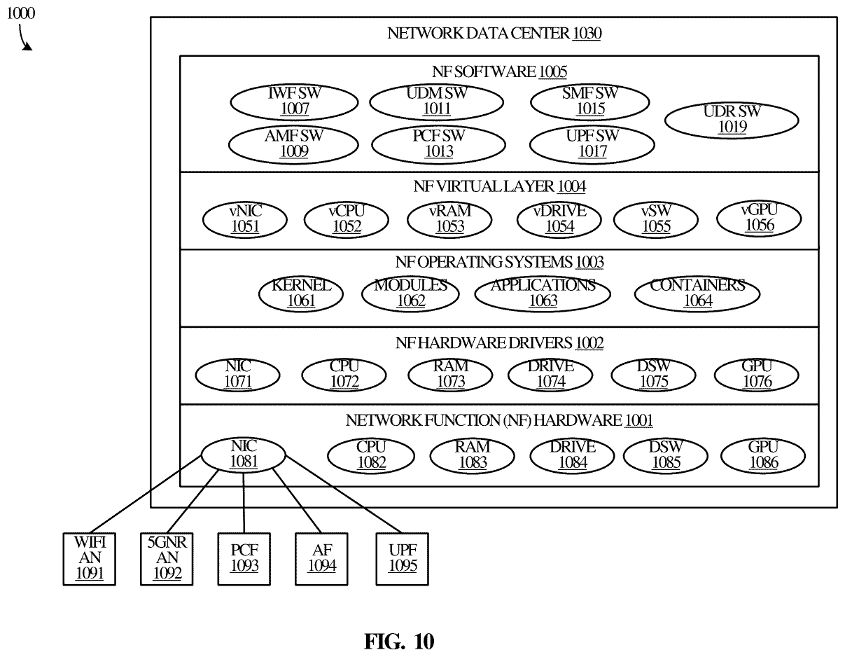

FIG. 10 illustrates exemplary network data center 1030, a network core of a wireless communication system, of which wireless communication network environment 100 of FIG. 1 is representative. Network data center 1030 is representative of a virtual structure of core network 105 and network core 1010. Network data center 1030 includes network function (NF) software 1005, network function virtual layer 1004, network function operating systems 1003, network function hardware drivers 1002, and network function hardware 1001.

Network function software 1005 of network data center 1030 includes software for executing various network functions: IWF software 1007, AMF software 1009, UDM software 1011, PCF software 1013, SMF software 1015, UPF software 1017, and UDR software 1019. Other network function software, such as network repository function (NRF) software, are typically present but are omitted for clarity.

Network function virtual layer 1004 includes virtualized components of network data center 1030, such as virtual NIC 1051, virtual CPU 1052, virtual RAM 1053, virtual drive 1054, virtual software 1055, and virtual GPU 1056. Network function operating systems 1003 includes components for operating network data center 1030, including kernels 1061, modules 1062, applications 1063, and containers 1064 for network function software execution. Network function hardware drivers 1002 include software for operating network function hardware 1001 of network data center 1030, including network interface card (NIC) drivers 1071 for network interface cards (NICs) 1081, CPU drivers 1072 for CPUs 1082, RAM drivers 1073 for RAM 1083, flash/disk drive drivers 1074 for flash/disk drives 1084, data switch (DSW) drivers 1075 for data switches 1085, and drivers 1076 for GPUs 1086. Network interface cards 1081 of network function hardware 1001 include hardware components for communicating with Wifi access node 1091 (e.g., Wifi AN 903), 5GNR access node 1092 (e.g., RAN 905), PCF 1093, application server 1094, and UPF 1095.

FIG. 11 illustrates computing device 1101 that is representative of any system or collection of systems in which the various processes, programs, services, and scenarios disclosed herein may be implemented. For example, computing device 1101 may be representative of any user equipment 101, portions of terrestrial access node 103, portions of non-terrestrial access node 107, ground network 108, core network 105, or data network 110. Examples of computing device 1101 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 1101 may be implemented as a single apparatus, system, or device or may be implemented in a distributed manner as multiple apparatuses, systems, or devices. Computing device 1101 includes, but is not limited to, processing system 1102, storage system 1103, software 1105, communication interface system 1107, and user interface system 1109 (optional). Processing system 1102 is operatively coupled with storage system 1103, communication interface system 1107, and user interface system 1109.

Processing system 1102 loads and executes software 1105 from storage system 1103. Software 1105 includes and implements scanning algorithms 1106, which are representative of the scanning algorithms and portions or sub-algorithms discussed with respect to the preceding FIGS, such as the steps described with respect to method 800 and the sub-algorithms of FIGS. 400-700. When executed by processing system 1102, software 1105 directs processing system 1102 to operate as described herein for at least the various processes, operational scenarios, and sequences discussed in the foregoing implementations. Computing device 1101 may optionally include additional devices, features, or functionality not discussed for purposes of brevity.

Referring still to FIG. 11, processing system 1102 may include a micro-processor and other circuitry that retrieves and executes software 1105 from storage system 1103. Processing system 1102 may be implemented within a single processing device but may also be distributed across multiple processing devices or sub-systems that cooperate in executing program instructions. Examples of processing system 1102 include general purpose central processing units, graphical processing units, application specific processors, and logic devices, as well as any other type of processing device, combinations, or variations thereof.

Storage system 1103 may include any computer readable storage media readable by processing system 1102 and capable of storing software 1105. Storage system 1103 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1103 may also include computer readable communication media over which at least some of software 1105 may be communicated internally or externally. Storage system 1103 may be implemented as a single storage device but may also be implemented across multiple storage devices or sub-systems co-located or distributed relative to each other. Storage system 1103 may include additional elements, such as a controller, capable of communicating with processing system 1102 or possibly other systems.

Software 1105 (including scanning algorithms 1106) may be implemented in program instructions and among other functions may, when executed by processing system 1102, direct processing system 1102 to operate as described with respect to the various operational scenarios, sequences, and processes illustrated herein. For example, software 1105 may include program instructions for implementing scanning algorithms as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1105 may include additional processes, programs, or components, such as operating system software, virtualization software, or other application software. Software 1105 may also include firmware or some other form of machine-readable processing instructions executable by processing system 1102.

In general, software 1105 may, when loaded into processing system 1102 and executed, transform a suitable apparatus, system, or device (of which computing device 1101 is representative) overall from a general-purpose computing system into a special-purpose computing system customized to support network traffic management function and/or load balancing processes in an optimized manner. Indeed, encoding software 1105 on storage system 1103 may transform the physical structure of storage system 1103. The specific transformation of the physical structure may depend on various factors in different implementations of this description. Examples of such factors may include, but are not limited to, the technology used to implement the storage media of storage system 1103 and whether the computer-storage media are characterized as primary or secondary storage, as well as other factors.

For example, if the computer readable storage media are implemented as semiconductor-based memory, software 1105 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1107 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 1101 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Unless the context clearly requires otherwise, throughout the description and the claims, the words “include,” “comprise,” “such as,” and “the like” are to be construed in an inclusive sense, as opposed to an exclusive or exhaustive sense, that is to say, in the sense of “including, but not limited to.” As used herein, the terms “connected,” ‘coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

What is claimed is:

1. A computer-implemented method, comprising:
determining, by a user equipment (UE), no terrestrial access nodes are available for attaching to a wireless communication network based on a standard scanning portion of a scanning process, wherein the standard scanning portion comprises scanning terrestrial spectrum bands of a wireless spectrum of frequencies, and wherein the terrestrial spectrum bands are associated with the terrestrial access nodes; and
performing, by the UE, a transient no coverage scanning portion of the scanning process in response to the determination, wherein the transient no coverage scanning portion prioritizes scanning non-terrestrial spectrum bands of the wireless spectrum, and wherein the non-terrestrial spectrum bands are associated with non-terrestrial access nodes.

2. The computer-implemented method of claim 1, wherein the transient no coverage scanning portion comprises:
scanning the non-terrestrial spectrum bands for a first duration;
sleeping for a second duration shorter than the first duration;
scanning the terrestrial spectrum bands for a third duration shorter than the first duration;
sleeping for a fourth duration shorter than the first duration; and
scanning the non-terrestrial spectrum bands for the first duration a second time.

3. The computer-implemented method of claim 1, further comprising:
in response to not acquiring a signal during the transient no coverage scanning portion, performing, by the UE, a steady state no coverage portion of the scanning process, wherein the steady state no coverage portion of the scanning process prioritizes battery life and includes scanning the non-terrestrial spectrum bands and the terrestrial spectrum bands intermittently.

4. The computer-implemented method of claim 3, wherein:
the steady state no coverage portion comprises:
scanning the non-terrestrial spectrum bands for a first duration,
sleeping for a second duration longer than the first duration, and
scanning the terrestrial spectrum bands for a third duration shorter than the second duration; and
the UE performs the steady state no coverage portion of the scanning process repeatedly until the signal is acquired.

5. The computer-implemented method of claim 1, further comprising:
in response to acquiring a signal from a non-terrestrial access node during the transient no coverage scanning portion:
establishing a connection via the non-terrestrial access node with the wireless communication network.

6. The computer-implemented method of claim 5, further comprising:
in response to establishing the connection and determining the UE is active, performing, by the UE, a steady state active portion of the scanning process, wherein the steady state active portion prioritizes maintaining the connection and includes scanning the terrestrial spectrum bands.

7. The computer-implemented method of claim 6, wherein the steady state active portion comprises:
a non-terrestrial prioritized loop comprising:
scanning the non-terrestrial spectrum bands for a first duration, and
sleeping for a second duration; and
after performing the non-terrestrial prioritized loop a predetermined number of times, scanning the terrestrial spectrum bands for a third duration longer than the first duration.

8. The computer-implemented method of claim 5, further comprising:
in response to establishing the connection and determining the UE is idle, performing, by the UE, a steady state idle portion of the scanning process, wherein the steady state idle portion prioritizes ensuring the signal is available and includes scanning the terrestrial spectrum bands.

9. The computer-implemented method of claim 8, wherein the steady state idle portion comprises:
a non-terrestrial prioritized loop comprising:
scanning the non-terrestrial spectrum bands for a first duration, and
sleeping for a second duration longer than the first duration; and
after performing the non-terrestrial prioritized loop a predetermined number of times, scanning the terrestrial spectrum bands for a third duration longer than the first duration and the second duration.

10. A user equipment, comprising:
one or more processors; and
one or more memories having stored thereon instructions that, upon execution by the one or more processors, cause the one or more processors to:
determine no terrestrial access nodes are available for attaching to a wireless communication network based on a standard scanning portion of a scanning process, wherein the standard scanning portion comprises scanning terrestrial spectrum bands of a wireless spectrum of frequencies, and wherein the terrestrial spectrum bands are associated with the terrestrial access nodes; and
execute a transient no coverage scanning portion of the scanning process in response to the determination, wherein the transient no coverage scanning portion prioritizes scanning non-terrestrial spectrum bands of the wireless spectrum, and wherein the non-terrestrial spectrum bands are associated with non-terrestrial access nodes.

11. The user equipment of claim 10, wherein the instructions to execute the transient no coverage scanning portion comprises instructions that, upon execution by the one or more processors, cause the one or more processors to:
scan the non-terrestrial spectrum bands for a first duration;
sleep for a second duration shorter than the first duration;
scan the terrestrial spectrum bands for a third duration shorter than the first duration;
sleep for a fourth duration shorter than the first duration; and
scan the non-terrestrial spectrum bands for the first duration a second time.

12. The user equipment of claim 10, wherein the instructions comprise further instructions that, upon execution by the one or more processors, cause the one or more processors to:
in response to not acquiring a signal during the transient no coverage scanning portion, execute a steady state no coverage portion of the scanning process, wherein the steady state no coverage portion of the scanning process prioritizes battery life and includes scanning the non-terrestrial spectrum bands and the terrestrial spectrum bands intermittently.

13. The user equipment of claim 12, wherein:
the further instructions to execute the steady state no coverage portion comprise instructions that, upon execution by the one or more processors, cause the one or more processors to:
scan the non-terrestrial spectrum bands for a first duration,
sleep for a second duration longer than the first duration, and
scan the terrestrial spectrum bands for a third duration shorter than the second duration; and
the further instructions, upon execution by the one or more processors, cause the one or more processors to:
execute the steady state no coverage portion of the scanning process repeatedly until the signal is acquired.

14. The user equipment of claim 10, wherein the instructions comprise further instructions that, upon execution by the one or more processors, cause the one or more processors to:
in response to acquiring a signal from a non-terrestrial access node during the transient no coverage scanning portion:
establish a connection via the non-terrestrial access node with the wireless communication network.

15. The user equipment of claim 14, wherein the further instructions, upon execution by the one or more processors, cause the one or more processors to:
in response to establishing the connection and determining a status of the user equipment is active, execute a steady state active portion of the scanning process, wherein the steady state active portion prioritizes maintaining the connection and includes scanning the terrestrial spectrum bands.

16. The user equipment of claim 15, wherein the further instructions to execute the steady state active portion comprise instructions that, upon execution by the one or more processors, cause the one or more processors to:
execute a non-terrestrial prioritized loop comprising:
scanning the non-terrestrial spectrum bands for a first duration, and
sleeping for a second duration; and
after executing the non-terrestrial prioritized loop a predetermined number of times, scan the terrestrial spectrum bands for a third duration longer than the first duration.

17. The user equipment of claim 14, wherein the further instructions, upon execution by the one or more processors, cause the one or more processors to:
in response to establishing the connection and determining a status of the user equipment is idle, execute a steady state idle portion of the scanning process, wherein the steady state idle portion prioritizes ensuring the signal is available and includes scanning the terrestrial spectrum bands.

18. The user equipment of claim 17, wherein the further instructions to execute the steady state idle portion comprise instructions that, upon execution by the one or more processors, cause the one or more processors to:
execute a non-terrestrial prioritized loop comprising:
scanning the non-terrestrial spectrum bands for a first duration, and
sleeping for a second duration longer than the first duration; and
after executing the non-terrestrial prioritized loop a predetermined number of times, scan the terrestrial spectrum bands for a third duration longer than the first duration and the second duration.

19. A non-transitory, computer-readable medium having stored thereon instructions that, upon execution by one or more processors, cause the one or more processors to:
determine no terrestrial access nodes are available for attaching to a wireless communication network based on a standard scanning portion of a scanning process, wherein the standard scanning portion comprises scanning terrestrial spectrum bands of a wireless spectrum of frequencies, and wherein the terrestrial spectrum bands are associated with the terrestrial access nodes; and
execute a transient no coverage scanning portion of the scanning process in response to the determination, wherein the transient no coverage scanning portion prioritizes scanning non-terrestrial spectrum bands of the wireless spectrum, and wherein the non-terrestrial spectrum bands are associated with non-terrestrial access nodes.

20. The non-transitory, computer-readable medium of claim 19, wherein the instructions to execute the transient no coverage scanning portion comprises instructions that, upon execution by the one or more processors, cause the one or more processors to:
scan the non-terrestrial spectrum bands for a first duration;
sleep for a second duration shorter than the first duration;
scan the terrestrial spectrum bands for a third duration shorter than the first duration;
sleep for a fourth duration shorter than the first duration; and
scan the non-terrestrial spectrum bands for the first duration a second time.
